(19) United States
(12) Patent Application Publication
(10) Pub. No.: US 2009/0164272 A1
(43) Pub. Date: Jun. 25, 2009

(54) Simulator

(76) Inventor: Robert Bittlestone, Surrey (GB)

Correspondence Address: WALKER & JOCKE, L.P.A., 231 SOUTH BROADWAY STREET, MEDINA, OH, 44256, US

(21) Appl. No.: 11/963,302

(22) Filed: Dec. 21, 2007

(51) Int. Cl. G06G 7/52; G06Q 10/00

(52) U.S. Cl. 705/7

(57) ABSTRACT

There can be provided a method for simulating a commercial entity. The method can comprise modelling the behaviour of a financial framework which describes the commercial entity, and displaying the results of the modelling to a user via a graphical interface which expresses value amount and value transfer as quantities within interconnected value volumes within a real-time display.

### FIELD

The present invention relates to a simulator, and in particular, but not exclusively to a business simulator.

### BACKGROUND

In many fields of human endeavour, it has become common to use a simulation environment for familiarisation and training purposes. For example, pilots are trained using flight simulators. Use of such a simulation environment allows a pilot or prospective pilot to learn new skills in a safe environment without a danger of death if a mistake is made.

The present invention has been conceived in the light of known drawbacks of existing systems.

### SUMMARY

The inventor has appreciated the advantages of known aviation flight simulators in protecting the user from a possibly terminal outcome in the event of a mistake, and has developed a system, apparatus and method to enable a user learning commercial and business techniques to practice without the danger of a real commercial entity failing.

According to one aspect, there is provided, a method of modelling a complex business environment to accurately represent the factors which influence the commercial success or failure of a business in accelerated time so as to provide rapid feedback on the outcome of different business management decisions.

This advantageously provides for a business student to be able to understand in real terms the outcome of a particular decision or decisions in managing a commercial entity and to be able to observe the short, medium and/or long term effect of that decision or decisions in a meaningful way without either a risk to a real commercial entity, or having to wait years to see the actual outcome.

In order to provide a realistic training environment, the method can be implemented using a computer program which models the flow of value around a business environment in a visual manner. In some examples, this visual representation can be analogous to the flow of liquid through a system of pipes and tanks. Thus value can be represented as a positive or negative quantity of water in a tank, with different tanks representing different assets, liabilities and different entities being interconnected by pipes which allow the flow of value therebetween in accordance with the rules of the model.

This visual representation can be extended to encompass such business description tools such as profit and loss accounts, cashflow and balance sheets, all of which can be interconnected using the pipe analogy.

By use of a such a system, the passage of time within the model can be increased or decreased to accelerate the occurrences within the model environment so that outcomes of different factors affecting the business, such as management decisions and external factors can be appreciated on an accelerated timescale. At the same time, a visual representation of the model can provide a view of the flow of value around the model in the real-time of the viewer and the accelerated time of the model.

In some arrangements, a model environment can include a number of competing businesses, each of which can be controlled by a different human controller, and the effects of competing businesses can be applied to the local part of the model environment viewed by the controller of one business within the environment.

In some arrangements, the rules which define the behaviour of the model can be a set of matrix equations which explain the underlying laws of financial accounting in a compact form.

Viewed from one aspect there can be provided a method for simulating a commercial entity. The method can comprise modelling the behaviour of a financial framework which describes the commercial entity, and displaying the results of the modelling to a user via a graphical interface which expresses value amount and value transfer as quantities within interconnected value volumes within a real-time display. Thereby a user can experience an easily understood interface to learn the complex issues surrounding business management and accountancy.

In some examples the modelling comprises performance of matrix operations on matrices defining starting value amounts and value transfer amounts for each value volume of the display via each interconnect. In this way, the displayed value volumes and the link between them can be direct representations of the flow of value through a commercial entity.

In some examples, the displaying comprises updating the graphical interface to shown new value amounts at each value volume at the end of each predetermined accounting period of the simulation. Thus the simulation can present to a user a real simulation-time updated interface to enable not only start and end points, but also middle points of the simulation to be observed. The accounting period can be 1 day.

In some examples the method further comprises receiving from a user data describing a desired parameter value for performance of the modelling. Thus the user can submit, for example, initial start conditions for the modelling before the simulation starts.

In some examples the method further comprises receiving from a user data describing a desired modelling or display operational parameter. Thus the user can control and alter certain aspects of the behaviour of the simulation to alter the behaviour of the commercial entity during the simulation, such that an interactive system is provided.

Viewed from another aspect, there can be provided a computer program product tangibly encoded on a computer-readable medium. The computer program can comprise instructions to cause a computer to carry out the previously described method.

Viewed from another aspect, there can be provided apparatus configured to carry out the previously described method.

Viewed from a further aspect there can be provided a method of modelling a value transfer in a financial framework. The method can comprise expressing the financial framework as a matrix with value nodes and value arcs on opposing axes, and calculating a current value for a given value node as the sum of the previous value for that value node with the matrix multiple of the financial framework matrix row or column for that value node with a one-dimensional matrix expressing the change value for each value node. Thereby an accounting framework can be expressed simply and concisely using matrix representations.

In some examples, the expressing can comprise providing a zero value for any intersection of a value node with a value arc that have no direct relation, and providing a unity magnitude value for any intersection of a value node with a value arc that have direct relation, the sign of the value being determined by the direction of value flow along that value arc relative to that value node. Thus the matrix framework can use a modified unity matrix to describe the behaviour of the accounting framework.

In some examples, the method can further comprise expressing calculated flows of the financial framework as a matrix with calculated flows and value arcs on opposing axes, and calculating a current value for a given calculated flow as matrix multiple of the financial framework matrix row or column for that calculated flow with the one-dimensional matrix expressing the change value for each value node. Thus composite value flows can be created using the same matric representation of the financial framework.

Viewed from another aspect, there can be provided a computer program product tangibly encoded on a computer-readable medium. The computer program can comprise instructions to cause a computer to carry out the previously described method.

Viewed from another aspect, there can be provided apparatus configured to carry out the previously described method.

Further objects and advantages of the invention will become apparent from the following description and the appended claims.

### BRIEF DESCRIPTION OF THE FIGURES

For a better understanding of the invention and to show how the same may be carried into effect reference is now made by way of example to the accompanying drawings in which:

FIG. 1 is a flowchart showing logical steps in a simulation process;

FIG. 2 shows a schematic view of a summary value flow representation;

FIG. 3 shows a schematic view of a detailed value flow representation;

FIG. 4 shows schematically an alternative flow of value structure.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### SPECIFIC DESCRIPTION

The present examples present a “business flight simulator” which enables existing and trainee business managers to undergo the real-time simulated experience of managing a business.

According to the system of the present examples, the Business Flight Simulator enables managers to learn how to run a business in a safe environment in which a negative outcome such as business failure or bankruptcy is not final.

According to the system of the present examples, even experienced persons can periodically return to the simulator for refresher courses, technique improvement and so on. Thus experienced managers can return to the Business Flight Simulator to refresh their knowledge of business, to learn how to improve their performance and also how to deal with potential problems.

According to the system of the present examples, the Business Flight Simulator can be programmed to represent the trading characteristics of a variety of different types of enterprise (retailing, manufacturing, insurance, banking etc.).

According to the system of the present examples, the Business Flight Simulator can be programmed with data about a specific company to enable detailed modelling of strategies for that specific company.

A business flight simulator according to the present examples can be implemented using a computer terminal, which optionally may be connected to a server computer and/or to one or more further computer terminals.

The computer terminal can be a conventional computer terminal, preferably one which uses an operating system which provides a graphical user interface, such as Microsoft Windows™, MAC OS™, Unix™ or compatible system, or Linux™ or compatible system.

The computer terminal can be loaded with software for causing an interface for the business flight simulator to be run and displayed, or such software can be run remotely at the terminal using a virtual machine type system such as a Java™ applet or a Flash™ or Shockwave™ type plug-in for a program such as a web browser.

Software to control the behaviour of the simulator can be loaded onto the terminal, and/or onto a server computer. This software can include a set of rules which define the operation of the model which underlies the simulator and can include specific data upon which the model can operate during operation of the simulator.

In some examples, multiple terminals can be interconnected, either directly or via a server. In such an arrangement, different users can control different commercial entities operating in the same commercial environment. The relationships between such companies can be, for example, direct competitor, indirect competitor, supplier, client, customer or any other relevant relationship.

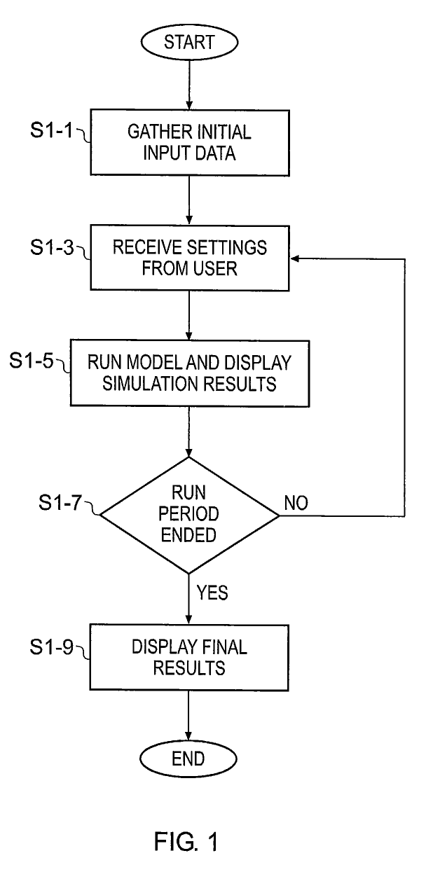

FIG. 1 shows a flowchart which details some logical steps in a simulation process, as might be employed by the business flight simulator.

Starting at Step S1-1, the simulation software gathers initial input data. This may come from a stored data resource and/or from data input by a user. This data can include information describing one or more commercial entities, as well as data describing market conditions and behaviours, such as capital and product reserves, outstanding debts, employee details, advertising programs etc of the commercial entities and interest rates, loan availabilities, stock market conditions, competitor entity data etc. This will be the starting data upon which the model operates at the start of the simulation. The model is initialized with the initial input data, and at Step S1-3 a user can configure certain settings for the company before the simulation commences. These settings can include, for example, rates of pay, rates of overpayment against loans, rates of calling in loans against debtors, payment of dividends to shareholders etc for a commercial entity which the user will control during the simulation. These settings are fed into the model.

At step S1-5, the simulation starts with the model providing for display in the simulator over a first period of time. This period of time may be a fixed period less than the duration of the simulation period, the whole of the simulation period, or a period of time of non-fixed length governed by an interruption from a user.

Once the model is paused or stopped, at step S1-7 a check is performed to determine whether the simulation is finished. If so the simulation provides final results to the user at step S1-9. If the simulation has not finished, such that the pause or halt is caused by either a timer time-out or a user interruption, processing continues by returning to step Si-3 where the user has an option to modify settings to alter the behaviour for the next period of the simulation.

As will be appreciated, many modifications of this process may be carried out, such as allowing modification of parameters without halting the simulation, and providing an option for further running after an intended run period has completed. Also the number of configurable settings may be increased or decreased, as may be the available ranges for each setting.

As will be appreciated, the manner in which the results are displayed to a user can be significant in aiding users learn from the results of the simulation. Thus, in the present examples, the display of simulation results as generated by the model are displayed in a “real-time” (i.e. in the real time of the user, but in the accelerated time of the simulation) manner, displaying the flow of value between different areas of the simulated commercial entity and between the simulated commercial entity and simulated external entities over time so as to enable the localised placement of value at any given time to be observed in relation to other possible value holding locations. In the present examples, the model calculates results for each day, with results for successive days being displayed in succession by the simulation interface. In other examples, the results could be calculated per half day, hour, week, fortnight, month or whatever other interval is useful to the user.

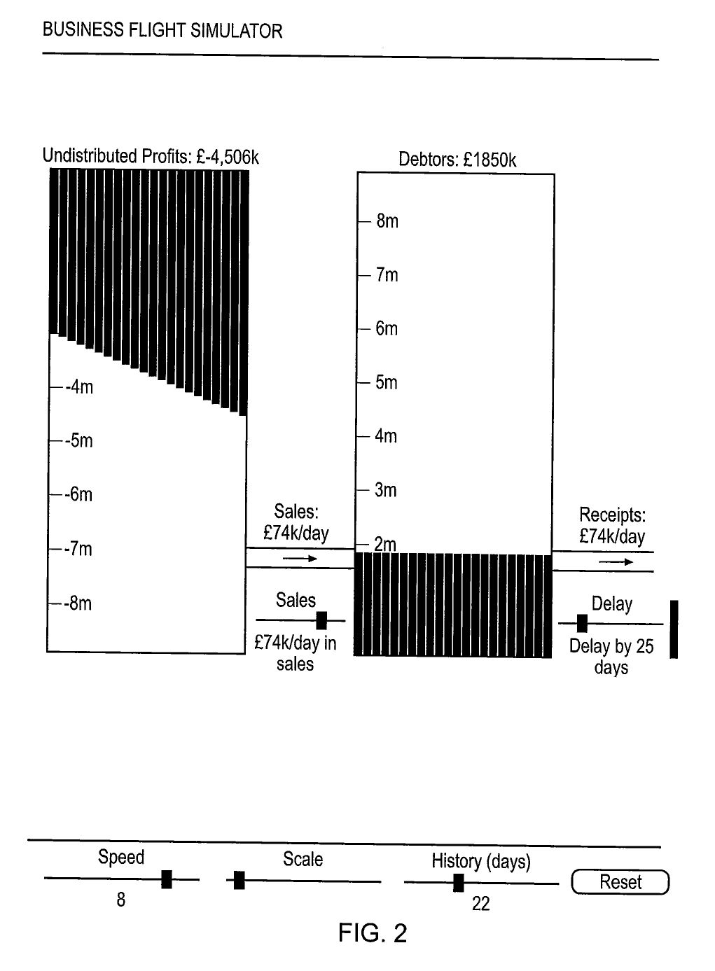

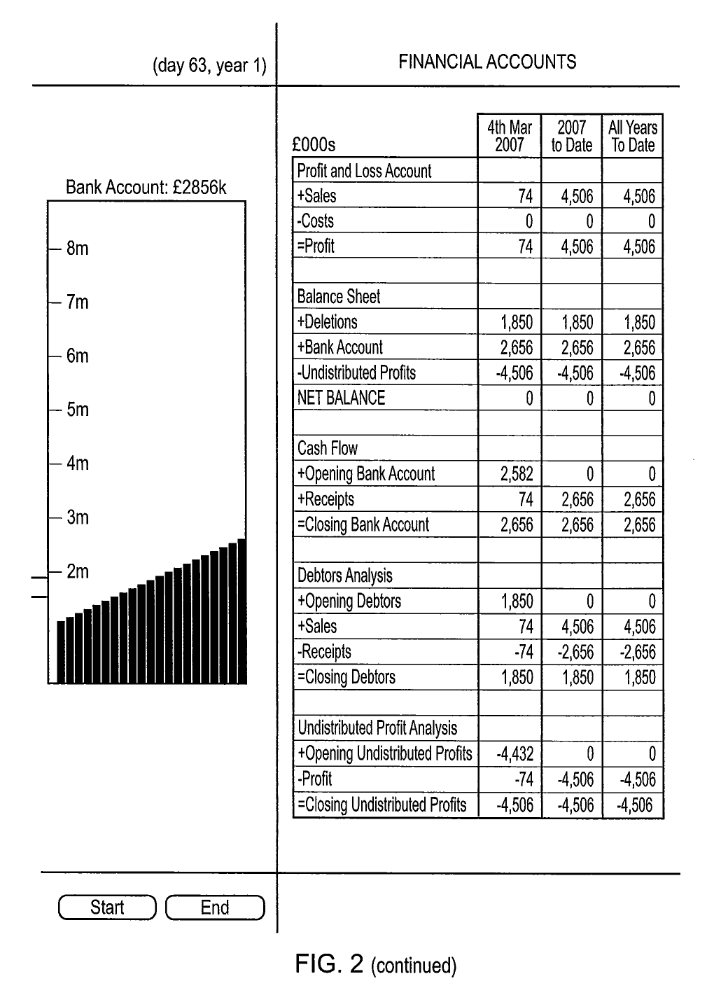

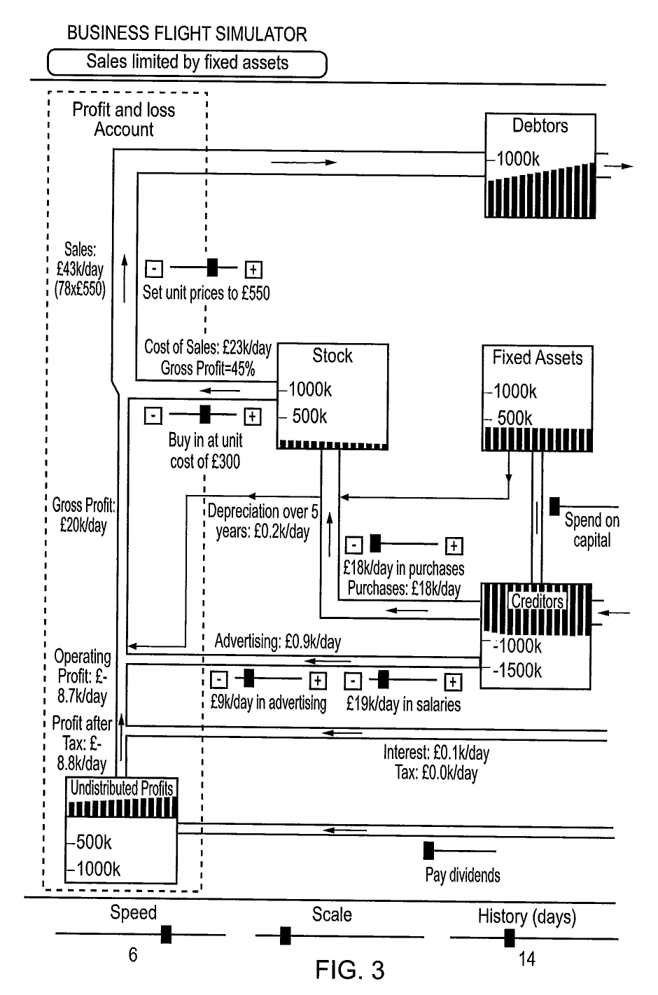

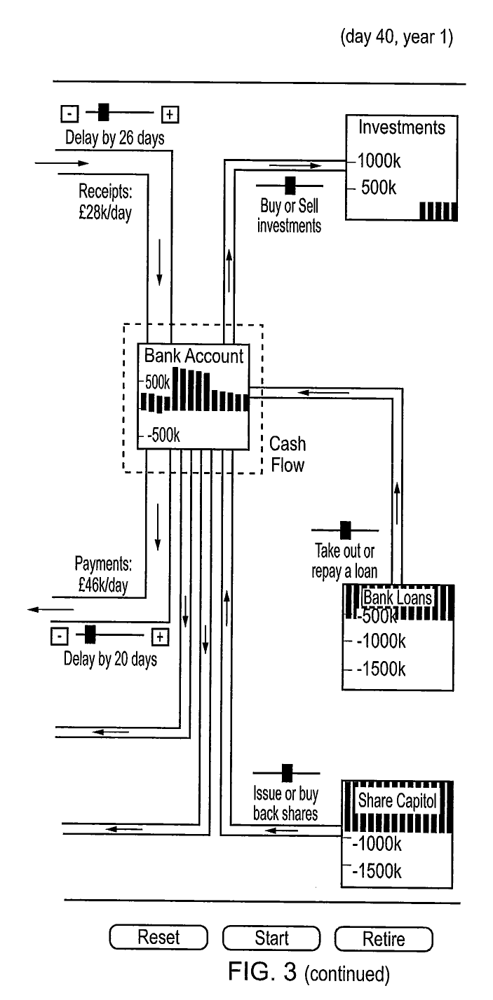

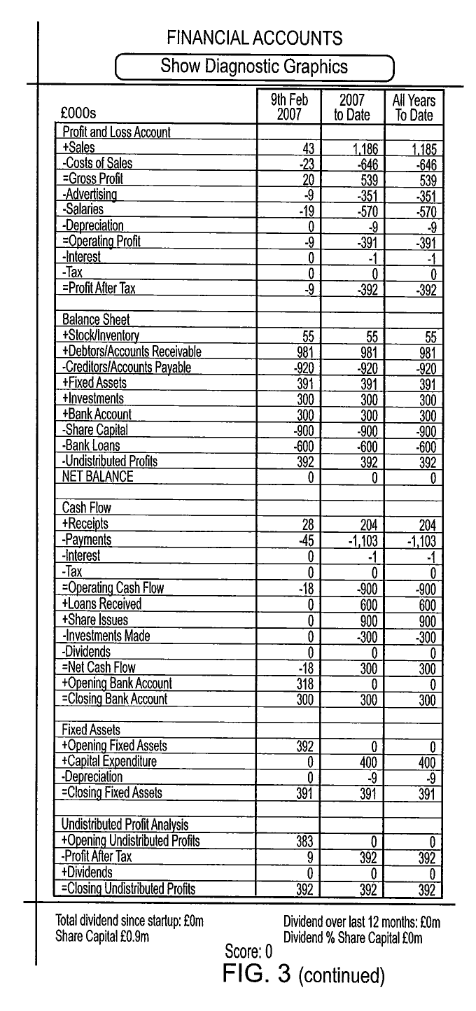

Examples of suitable graphical representations are shown in FIGS. 2 and 3. FIG. 2 shows a simple representation of value flow of a commercial entity. In FIG. 2, the image is shown of flow between undistributed profits, debtors and bank account, along with tabular descriptions of the amounts and flows of value. In the example of FIG. 2, the simulation has been halted at day 63 of year 1 of the simulation. The flow of value over time is represented by alterations in the levels of each of the three “value tanks”. Thus, at a previous display interval (for example day 62) the levels (and figures) may have been different, and at a future display interval (for example day 64) the levels (and figures) may be different.

As can be seen, the simulation interface in the example of FIG. 2 provides options for increasing or decreasing the speed of the simulation, altering the scale on the value tanks, and for altering the amount of history shown in the value tanks.

As can be seen from FIG. 2, the value tanks can display not only a current value quantity, but also a history of the value quantity. For example, in FIG. 2, it can be seen that over the past 22 days the amount of value held at the bank account has increased (time flow left to right), whereas the amount of value of the undistributed profits has decreased (become more negative).

FIG. 3 shows a more complex representation of flow of value for a commercial entity. This more complex display shows the alteration in the amounts of, for example stock, fixed assets, creditors, investments, bank loans, and share capital in addition to those items featured in the display of FIG. 2. As in FIG. 2, there are also tabular descriptions of the amounts and flow of value. The display specifically indicates those parts of the display which relate directly to the profit and loss account, for ease of understanding by a user.

The example of FIG. 3, also provides for alteration of a large number of variables. In addition to speed, scale and history (which were available in the example of FIG. 2), the display of the example of FIG. 3 allows alteration of certain values within the simulation, which altered values can be fed back to the model for inclusion in future simulation results. Examples of variables which can be user altered include stock price (buy and sell), capital spending, purchase spending, advertising spending, salary spending, dividend payments, issuance or buy back rate for shares, loan advances/repayments, investment sales/purchases, delays between invoicing and receipts etc. Alteration of these variables can allow a user to alter the commercial behaviour of a business and view the outcome of decisions such as increasing a loan repayment rate or holding a greater volume of stock.

As in the example of FIG. 2, the example of FIG. 3 is a display for a specific day in the lifetime of the simulation, in the present example, day 40 of year 1 of the simulation. As has been mentioned above, the simulation can be paused or accelerated according to the user's requirements to allow changes in value locations over time to be monitored and further settings to be altered to change the future behaviour of the commercial entity.

The constantly updating display of information about the simulated commercial entity, in an easily understood graphical format enables a user to grasp very quickly the impact of certain alterations of certain operating conditions on the performance of the simulated commercial entity. This facilitates use of the simulation for training and education purposes, as well as for outcome prediction where an existing commercial entity wishes to model the possible outcomes of certain proposed business changes.

As will be appreciated, the graphical representation of the simulation described above uses results derived from a model of a commercial environment including one or more simulated commercial entities. In some examples, the model employed by the simulation can be a computationally compact mathematical model of the commercial environment, so as to facilitate swift operation of the model, so as to allow accurate yet highly accelerated modelling of a simulated commercial entity where a user in interested only in, for example, quarterly or annual progress of a simulated commercial entity.

The skilled reader will appreciate that the results displayed in FIGS. 2 and 3 can be generated from a table of transactions, the table describing the parties (source and destination of value), value and timing of the transaction. Preferably, a description of the transaction would be included for ease of data auditing, but is not essential to generation of the results. In the context of a model which gives rise to the simulation results shown in FIG. 3, the parties would be one or more of the “value tanks” and the transaction would be conducted along one of the “value transfer pipes”, usually along a single length of value transfer pipe directly interconnecting two value tanks. For example a transaction could take place between, for example creditors and stock, or between bank account and share capital, but typically not between share capital and undistributed profits. Working from such a table of transfers, it is possible to construct a set of rules which govern all possible transfers within a given simulation environment. However, due consideration must be given to the fact that different companies will have different combinations of value tanks, interconnected by different patterns of value pipes.

In the present examples, a mathematical model which can describe arrangements such as those shown in FIGS. 2 and 3 can be created using a model which uses two object types: nodes which represent points in the graph, and arcs which join them up. Thus it can be seen that according tot his model, the value tanks are nodes and the value pipes are arcs. As the model relates to movement of value around a financial environment, the arcs can be defined as mono-directional, and it can be assumed that none of the arcs will be re-entrant (ie they do not start and end at the same node). Thus the arcs convey value from start to end over discrete intervals of time. At any instant, the values are contained within the nodes, which accumulate the integral of all incident arc values.

Based on such a framework, the model can be used to summarise an accounting framework (a ‘chart of accounts’) in a succinct manner. The fundamental mathematical technique employed is matrix multiplication, which the skilled reader will appreciate is a technique well suited to implementation by computer.

An example of an accounting framework expressed as a matrix is shown in Table 1 below.

TABLE 1
The Accounting Framework as a Matrix, “M”

| | | Cost | | | | | | | | | | Invest- | | |
|---|---|---|---|---|---|---|---|---|---|---|---|---|---|---|
| | | of | Depre- | Ex- | | | | Pur- | Capital | | Pay- | ment | Share | Loan |
| | Sales | sales | ciation | penses | Interest | Tax | Dividends | chases | expenditure | Receipts | ments | payments | issues | receipts |
| UNDIS- | −1 | +1 | +1 | +1 | +1 | +1 | +1 | | | | | | | |
| TRIBUTED | | | | | | | | | | | | | | |
| PROFIT | | | | | | | | | | | | | | |
| STOCK | | −1 | | | | | | +1 | | | | | | |
| DEBTORS | +1 | | | | | | | | | −1 | | | | |
| BANK | | | | | −1 | −1 | −1 | | | +1 | −1 | −1 | +1 | +1 |
| ACCOUNT | | | | | | | | | | | | | | |
| BANK | | | | | | | | | | | | | | −1 |
| LOANS | | | | | | | | | | | | | | |
| SHARE | | | | | | | | | | | | | −1 | |
| CAPITAL | | | | | | | | | | | | | | |
| INVEST- | | | | | | | | | | | | +1 | | |
| MENTS | | | | | | | | | | | | | | |
| CREDITORS | | | | −1 | | | | −1 | −1 | | +1 | | | |
| FIXED | | | −1 | | | | | | +1 | | | | | |
| ASSETS | | | | | | | | | | | | | | |
| TOTAL | 0 | 0 | 0 | 0 | 0 | 0 | 0 | 0 | 0 | 0 | 0 | 0 | 0 | 0 |

Table 1 shows in itemised form all of the value tanks or nodes on the rows (in capital letters) and all the flows which affect them in the columns (lower case). The node called Undistributed Profits can be regarded as occupying the whole space of the Profit and Loss Account and so can be omitted from the calculated flow values which are wholly internal to it (Gross Profit, Operating Profit and Profit before Tax). If a flow starts at a box (i.e. leaves from it) then at the intersection of that column and row in the table there is entered the value −1; if a flow ends at a box (i.e. goes into it) then at the intersection of that row and column in the table there is entered the value +1; if a flow does not affect a box at all then a value of 0 is entered.

Since all of the value pipes or arcs on the diagram start at one box and end at another, it follows that a given flow (a column) can have only one −1 value and one +1 value. This means that all columns must add up to a net value of 0, which has been highlighted on the bottom at the Total row. This simple mathematical statement is equivalent to the accounting rule of double-entry.

If it is assumed that the simulation model has been run, such that for a given day there are already two lists of data: the opening values in each of the balance-sheet boxes at the start of the day (Table 2), and the value of each flow transaction flowing through the pipes during that day (Table 3). The test for a model is whether it can work out what the closing values of the balance-sheet boxes will be at the end of the day? It turns this model can, and with considerable mathematical economy.

TABLE 2
List of opening balance sheet values, “B”

| | OPENING VALUES |
|---|---|
| UNDISTRIBUTED PROFIT | −200 |
| STOCK | 100 |
| DEBTORS | 250 |
| BANK ACCOUNT | 100 |
| BANK LOANS | −50 |
| SHARE CAPITAL | −100 |
| INVESTMENTS | 30 |
| CREDITORS | −80 |
| FIXED ASSETS | 50 |
| TOTAL | 0 |

TABLE 3
List of original flow values, “F”

| | | Cost of | Depre- | Ex- | | | | Pur- | Capital | | Pay- | Investment | Share | Loan |
|---|---|---|---|---|---|---|---|---|---|---|---|---|---|---|
| | Sales | sales | ciation | penses | Interest | Tax | Dividends | chases | expenditure | Receipts | ments | payments | issues | receipts |
| VALUES | 80 | 30 | 2 | 10 | 3 | 10 | 5 | 40 | 15 | 90 | 35 | 10 | 0 | 5 |
| DURING | | | | | | | | | | | | | | |
| THE DAY | | | | | | | | | | | | | | |

Working from a simple case such as the second row of matrix “M”, which contains the Stock balance sheet item, the matrix indicates that only two flows affect this: Cost of Sales flows out (−1) while Purchases flows in (+1). None of the other flows affect it; they are all 0 values. So if the Stock line of matrix “M” is considered (extracted as Table 4),

TABLE 4
Extract of the Stock row of Matrix M

| | | Cost of | Depre- | Ex- | | | | | Capital | | Pay- | Investment | Share | Loan |
|---|---|---|---|---|---|---|---|---|---|---|---|---|---|---|
| | Sales | sales | ciation | penses | Interest | Tax | Dividends | Purchases | expenditure | Receipts | ments | payments | issues | receipts |
| STOCK | 0 | −1 | 0 | 0 | 0 | 0 | 0 | +1 | 0 | 0 | 0 | 0 | 0 | 0 |

and if each cell of Table 3 is multiplied by the corresponding cell of Table 4, the following is the result (Table 5):

TABLE 5
Effect of inflows and outflows on the level of Stock

| | | Cost of | Depre- | Ex- | | | | | Capital | | Pay- | Investment | Share | Loan |
|---|---|---|---|---|---|---|---|---|---|---|---|---|---|---|
| | Sales | sales | ciation | penses | Interest | Tax | Dividends | Purchases | expenditure | Receipts | ments | payments | issues | receipts |
| Change | 0 | −30 | 0 | 0 | 0 | 0 | 0 | +40 | 0 | 0 | 0 | 0 | 0 | 0 |
| in | | | | | | | | | | | | | | |
| STOCK | | | | | | | | | | | | | | |
| values | | | | | | | | | | | | | | |

This result indicates that there has been an outflow of −30 via Cost of Sales, and an inflow of +40 via Purchases. If values are added together, a net change of +10 is found. Comparison of this model result to the accounting figures shows that this is precisely how the level of Stock has changed during the day: it has increased by 10. The Closing Stock is therefore equal to its Opening value of 100 (from list B in Table 2)+10, in other words it is now standing at a closing value of 110.

It is thus clear that the whole of double-entry accountancy can be represented by a single matrix equation.

Bₜ₊₁=Bₜ+M [symbol] F_{t,t+1}

where:

Bₜ is the balance sheet vector at time t (Table 2);

M is the accounting framework matrix (Table 1) in which a value of +1, 0 or −1 selects the appropriate original flow such that all column totals add to 0;

[symbol] denotes the operation of matrix multiplication;

F_{t,t+1} is the original flow value vector between periods t and t+1 (Table 3).

This equation encapsulates the rule for updating any balance sheet of any complexity, driven by any set of transactions over any period of time. There may be tens of thousands of customer accounts (individual Debtors) and hundreds of thousands of sales values, but the equation stays the same; and it can be implemented as it stands on any computer system that can handle matrix manipulation.

It has been demonstrated that this equation works for the original box-to-box flows in the accounting framework. However, accountants are often most concerned with the Profit and Loss account. Such calculations can be carried out using a matrix expression in which we have a new matrix N that looks similar to matrix M in Table 1, but this time with the calculated flow names in the rows and the original flow names in the columns (Table 6).

TABLE 6
Calculated Flows as a Matrix, “N”

| | | | | | | | | | | | | | |
|---|---|---|---|---|---|---|---|---|---|---|---|---|---|
| | Cost of | Depre- | Ex- | | | | | Capitals | | Pay- | Investment | Share | Loan |
| Sales | sales | ciation | pense | Interest | Tax | Dividends | Purchases | expenditure | Receipts | ments | payments | issues | receipts |

| | | | | | | |
|---|---|---|---|---|---|---|
| Gross | +1 | −1 | | | | |
| Profit | | | | | | |
| Operating | +1 | −1 | −1 | −1 | −1 | |
| Profit | | | | | | |
| Profit | +1 | −1 | −1 | −1 | −1 | −1 |
| after tax | | | | | | |

This then gives rise to a second equation:

G_{t,t+1}=N [symbol] F_{t,t+1}

where:

G_{t,t+1} is the calculated flow value vector between periods t and t+1;

N is the calculated flow matrix in which +1, 0 or −1 selects the appropriate original flows;

[symbol] denotes the operation of matrix multiplication;

F_{t,t+1} is the original flow value vector between periods t and t+1 (Table 3).

Staring from this approach allows alteration and experimentation with different layouts for the displays in FIGS. 2 and 3 which nevertheless preserve the same underlying framework of relationships. For example, supposing a calculation of Net Cash Flow is required. All that is required is to add to matrix N a further row (Table 7).

TABLE 7
Adding calculated cash flows to Matrix “N”

| | | Cost of | Depre- | Ex- | | | | Pur- | Capital | | Pay- | Investment | Share | Loan |
|---|---|---|---|---|---|---|---|---|---|---|---|---|---|---|
| | Sales | sales | ciation | penses | Interest | Tax | Dividends | chases | expenditure | Receipts | ments | payments | issues | receipts |
| Operating | | | | | | | | | | +1 | −1 | | | |
| cash flow | | | | | | | | | | | | | | |
| Net cash | | | | | −1 | −1 | −1 | | | +1 | −1 | −1 | +1 | +1 |
| flow | | | | | | | | | | | | | | |

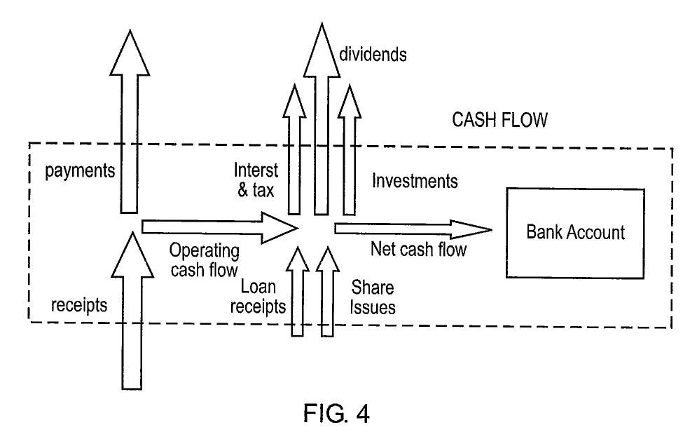

Because there is no fundamental difference between structures such as Table 6 and Table 7, it then becomes clear that, for example, the Cash Flow zone around the Bank Account could be redrawn in much the same way as for the Profit and Loss area (see FIG. 4). In short, whenever a series of flows enters and leaves a value tank or node, it is always possible to redraw the diagram by defining one or more calculated flows that impact it instead.

This approach allows not only the performance of matrix arithmetic on the flows, we individual value tanks or nodes can be disaggregated or consolidated via the same technique. As discussed above, unless the business has only a single customer, there will not be just one Debtor: there may well be several thousands of them. These relationships can also be represented via a matrix such as N, but this time it is used to add the boxes rather than the flows together.

The model description and equations of the present examples, thus provide a detailed an accurate representation of double-entry accounting via a rigorous definition of what the accounting process is trying to achieve. The matrix formulation of the present examples describes the underlying nature of the accounting structure itself without presupposing the identity of any specific balances, and thereby applying some form of “special” identify to one value tank over and above another value tank. A particular benefit of this approach is that the provision of a clear mathematical formulation for accountancy enables new minds from other backgrounds to be brought to bear on the issues that arise within it. Accountancy has sometimes tended to be seen as a priestly ritual, accessible only to the cognoscenti after a relatively lengthy indoctrination. By contrast, mathematics is an inter-disciplinary shorthand that can convey the essence of a subject to others who have not experienced such a tutelage. This constituency includes managers, marketing and sales people, production experts, computer and information technology specialists and of course also the educated general public. Their exposure to the fundamentals of accountancy may bring with it unexpected insights and benefits.

Thus there have been described methods, apparatus and systems for modelling of a financial framework. The results of such a model can be applied to a simulation of a commercial environment or to day to day accounting practices. Where a simulator is implemented, the results from the model can be displayed in a real-time easily understood graphical manner which enables a user to easily grasp the flow of value around a commercial environment over time, and to view and understand the impact of altering certain parameters of the commercial environment.

What is claimed is:

1. A method for simulating a commercial entity, the method comprising:
modelling the behaviour of a financial framework which describes the commercial entity;
displaying the results of the modelling to a user via a graphical interface which expresses value amount and value transfer as quantities within interconnected value volumes within a real-time display.

2. The method of claim 1, wherein the modelling comprises performance of matrix operations on matrices defining starting value amounts and value transfer amounts for each value volume of the display via each interconnect.

3. The method of claim 1, wherein the displaying comprises updating the graphical interface to shown new value amounts at each value volume at the end of each predetermined accounting period of the simulation.

4. The method of claim 4, wherein the accounting period is 1 day.

5. The method of claim 1, further comprising receiving from a user data describing a desired parameter value for performance of the modelling.

6. The method of claim 1, further comprising receiving from a user data describing a desired modelling or display operational parameter.

7. A computer program product, tangibly encoded on a computer-readable medium, the computer program comprising instructions to cause a computer to carry out a method for simulating a commercial entity, comprising:
modelling the behaviour of a financial framework which describes the commercial entity;
displaying the results of the modelling to a user via a graphical interface which expresses value amount and value transfer as quantities within interconnected value volumes within a real-time display.

8. A method of modelling a value transfer in a financial framework, the method comprising:
expressing the financial framework as a matrix, with value nodes and value arcs on opposing axes; and
calculating a current value for a given value node as the sum of the previous value for that value node with the matrix multiple of the financial framework matrix row or column for that value node with a one-dimensional matrix expressing the change value for each value node.

9. The method of claim 8, wherein the expressing comprises providing a zero value for any intersection of a value node with a value arc that have no direct relation, and providing a unity magnitude value for any intersection of a value node with a value arc that have direct relation, the sign of the value being determined by the direction of value flow along that value arc relative to that value node.

10. The method of claim 8, further comprising expressing calculated flows of the financial framework as a matrix with calculated flows and value arcs on opposing axes, and calculating a current value for a given calculated flow as matrix multiple of the financial framework matrix row or column for that calculated flow with the one-dimensional matrix expressing the change value for each value node.

11. A computer program product, tangibly encoded on a computer-readable medium, the computer program comprising instructions to cause a computer to carry out a method of modelling a value transfer in a financial framework, comprising:
expressing the financial framework as a matrix, with value nodes and value arcs on opposing axes; and
calculating a current value for a given value node as the sum of the previous value for that value node with the matrix multiple of the financial framework matrix row or column for that value node with a one-dimensional matrix expressing the change value for each value node.
